(19) United States
(12) Patent Application Publication
(10) Pub. No.: US 2025/0112383 A1
(43) Pub. Date: Apr. 3, 2025

(54) EXTENDED-RANGE HIGH-SPEED INTERCONNECT

(71) Applicant: Apple Inc., Cupertino, CA (US)

(72) Inventors: Steven Webster, Singapore (SG); Henry M. Daghighian, Cupertino, CA (US); Jee Tung Tan, Singapore (SG); Peter Chin Ting Soon, Singapore (SG)

(73) Assignee: Apple Inc., Cupertino, CA (US)

(21) Appl. No.: 18/378,091

(22) Filed: Oct. 9, 2023

Related U.S. Application Data
(60) Provisional application No. 63/541,711, filed on Sep. 29, 2023.

(51) Int. Cl. H01R 12/62; H01R 12/77; H01R 13/6592; H01R 24/50

(52) U.S. Cl. CPC H01R 12/62; H01R 12/775; H01R 13/6592; H01R 24/50

(57) ABSTRACT

Examples can provide extended-range high-speed interconnect by providing microcoax cables in a hybrid flexible circuit board, which can be referred to as a hybrid flex or microcoax flex. This hybrid flex can be used to convey signals an extended distance within an electronic device. Multiple signals can be conveyed using corresponding microcoax cables. The microcoax cables can include a center conductor, an insulating layer, and an outside shield layer. The cables can be held in position in the hybrid flex relative to each other by a polyimide or other insulative layer. Copper layers can be provided on either or both the top and bottom of the polyimide or other insulative layer. Additional conductors can be embedded in the polyimide other insulative layer to convey power and ground. The microcoax and other conductors can be soldered to a flexible circuit board or other substrate using jet soldering.

### CROSS-REFERENCES TO RELATED APPLICATIONS

The present application claims the benefit of and priority to U.S. provisional application 63/541,711, filed Sep. 29, 2023, which is incorporated by reference.

### BACKGROUND

The number of types of electronic devices that are commercially available has increased tremendously the past few years and the rate of introduction of new devices shows no signs of abating. Devices such as tablet computers, laptop computers, all-in-one computers, desktop computers, cell phones, storage devices, wearable-computing devices, portable media players, portable computing devices, navigation systems, monitors, audio devices, remotes, adapters, and others have become ubiquitous.

These electronic devices can include several high-speed circuits that can generate or process tremendous amounts of data. For example, a connector on an electronic device can receive and transmit large amounts of data at a high rate. Processors can receive vast amounts of data from wireless circuits, cameras, sensors, and other circuits.

These communicating circuits can be placed a distance from each other in an electronic device. But it can be very difficult to transfer data at a high-speed over a distance within an electronic device. For example, conventional flexible circuit boards can degrade signals and generate a large amount of electromagnetic interference even over a short distance. Strip-line techniques can help but are often lacking. Thus, it can be desirable to have high-speed interconnect that can traverse distances in an electronic device. It can also be desirable that these interconnects can be used in external applications as well, for example in a cable that can connect two electronic devices.

Since these communicating circuits are at a distance, there can be intervening circuits or components physically positioned between them. This can require an interconnect to be routed around the intervening circuits or components. Thus, it can be desirable that these interconnects are highly flexible. Also, some electronic devices can be manufactured in large volumes. To meet the demand for these electronic devices, it can be desirable that they be readily manufactured.

Thus, what is needed are interconnect that can convey high-speed data over long distances within an electronic device, is highly flexible, and is readily assembled.

### SUMMARY

Accordingly, embodiments of the present invention can provide interconnect that can convey high-speed data over long distances within an electronic device, is highly flexible, and is readily assembled. An illustrative embodiment of the present invention can provide extended-range high-speed interconnect by providing microcoaxial cables, referred to here as microcoax cables, in a hybrid flex circuit board, which can be referred to as a hybrid flex. This hybrid flex can be used to convey signals an extended distance within an electronic device. Multiple signals can be conveyed using corresponding microcoax cables. The microcoax cables can include a center conductor, an insulating layer, and an outside shield layer. The cables can be held in position in the hybrid flex relative to each other by a polyimide or other insulative layer. Conductive layers can be provided on either or both the top and bottom of the polyimide or other insulative layer. The conductive layers can be formed of copper, copper alloy, or other conductive material. Additional conductors can be embedded in the polyimide other insulative layer to convey power and ground. The additional conductors can include bare wire that can be either stranded or solid, magnet (or mag) wire, enameled wire, or other types of wires. The microcoax and other conductors can be soldered to a printed circuit board, flexible circuit board, or other substrate using jet soldering.

An illustrate embodiments of the present invention can provide a highly flexible, high-speed interconnect structure. The interconnect structure, which can be referred to as a microcoax flex or hybrid flex, can include one, two, three, four, or more than four first microcoax cables. The interconnect structure can further include one, two, three, four, or more than four power and ground conductors for power supplies, grounds, and other high-current paths. The interconnect structure can include one, two, three, four, or more than four second microcoax cables.

The conductors for this hybrid flex can be arranged in various ways. For example, four first microcoax cables can be positioned on a first side and two second microcoax cables can be placed on a second side. Three power and ground conductors can be placed between the first microcoax cables and the second microcoax cables. The three power and ground conductors can be allocated as one power conductor and two ground conductors.

The first microcoax cables and the second microcoax cables can be similar or the same, or they can be different. The first microcoax cables and second microcoax cables can each include a center conductor for conveying a signal, and insulating layer, and an outside ground shield. The ground shields for each microcoax cable can attach to a layer of copper, copper alloy, or other conductive material on a bottom side. They can further attach to a layer of copper, copper alloy, or other conductive material on a top side.

The power and ground conductors can be solid wires, they can be stranded wires, they can be magnet wire, enameled wire, or they can be other types of wire.

The first microcoax cables, the power and ground conductors, and the second microcoax cables can be secured to each other in an insulating layer. The insulation layer can be formed of polyimide or other insulating material that is flexible. The copper, copper alloy, or other conductive layers can be attached to either or both a top side and a bottom side of the insulating material. The copper, copper alloy, or other conductive layers can contact or connect to the shields for the first microcoax cables and the second microcoax cables. The copper, copper alloy, or other conductive layers can contact or connect to the ground conductors. The power conductors can be isolated from the copper, copper alloy, or other conductive layers using pieces or layers of insulation.

These and other embodiments of the present invention can utilize various microcoax cables. These microcoax cables can have a center conductor. The center conductor can be a solid wire or a stranded wire, such as a Litz wire. The center conductor can be insulated with an insulating layer, which can be formed of polyethylene or other flexible insulating material. The outer side of the insulating layer can be covered with a metalized shield. For example, the insulating layer can be covered in a shield formed of a conductive braiding, foil, or other type of layer. This shielding can be formed of copper, copper alloy, aluminum, or other material.

These microcoax cables can be soldered to a circuit board or other substrate using jet soldering. For example, the center conductor can be soldered to a trace of a board using jet soldering. One or both sides of a shield can be soldered to one or more ground pads of a circuit board or other substrate using jet soldering.

This jet soldering can include feeding a solder ball to a nozzle. The solder balls can be stored in a hopper awaiting their turn. The solder ball can be heated with a laser or by other method. The solder ball can be heated with a laser and then expelled by pressurized nitrogen towards a target.

These and other embodiments of the present invention can include various passive and active components in a hybrid flex. For example, components for filter power supply voltages, terminating cables, and other components can be included. These components can be formed of thin film multi-ferroics. For example, ferroelectric tunable thin-film capacitors can be included. These thin-film capacitors can decouple power supply voltages conveyed on one of the power and ground conductors. Such a capacitor can be connected between a power supply conductor and a ground conductor. Control voltages can be conveyed to the thin-film capacitors via wires in the hybrid flex. Other components, such as a choke, can be included. Filter circuits such as Pi filters, voltage tunable pi filters, and other power line noise filters can be implemented. The choke can be implemented using a ferromagnetic thin-film ferrite. These structures can be fabricated in the hybrid flex using planar fabrication techniques.

For example, a number of microcoax cables and other conductors can be partially molded in an insulator such that a bottom portion of the microcoax cables are molded a top portion are not molded. Conductive traces or other conduits for power and ground can be placed on this middle level of insulator. Thin-film multi-ferroics structures such as capacitors and chokes can be formed in contact with these conductive traces or other conduits. The remaining exposed portions of the microcoax cables can then be molded.

These and other embodiments of the present invention can provide a low-profile hybrid flex connector. This connector can include a hybrid flex having conductors terminating in solder connections to pads on top of a first board. A polyimide mold or ferrite loaded mold (EMI shield) can be placed over the solder terminations and pads on the first board. The first board can have through connections to pads on the bottom of the first board. The pads on the bottom of the board can connect to pads on a second board. The second board can be a main-logic board or other board. The pads on the bottom of the first board can be connected to pads on the second board using an anisotropic conductive film. The first board and the second board can be connected to each other using interlocking screws or other fasteners.

Embodiments of the present invention can provide hybrid flexes that can be located in various types of devices, such as tablet computers, laptop computers, desktop computers, all-in-one computers, cell phones, storage devices, wearable-computing devices, portable computing devices, portable media players, navigation systems, monitors, audio devices, remotes, adapters, and other devices.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic device that can be improved by the incorporation of embodiments of the present invention;

FIG. 2 is a top view of a hybrid flex according to an embodiment of the present invention.

FIG. 3 is a cutaway side view of the hybrid flex of FIG. 2;

FIG. 4A and FIG. 4B illustrate a microcoax cable used in embodiments of the present invention;

FIG. 5 illustrates soldered structures formed using jet-soldering according to an embodiment of the present invention;

FIG. 6 illustrates an apparatus and method of forming solder-jet connections according to an embodiment of the present invention;

FIG. 7 illustrates an apparatus and method of forming solder-jet connections according to an embodiment of the present invention;

FIG. 8 illustrates an eye diagram for a PAM4 signal being conveyed by a hybrid flex according to an embodiment of the present invention;

FIG. 9 illustrates the pre-emphasis that can be used in transmitting the PAM4 signal of FIG. 18;

FIG. 10 illustrates the insertion loss for a hybrid flex according to an embodiment of the present invention;

FIG. 11 illustrates the electromagnetic interference generated by a hybrid flex according to an embodiment of the present invention;

FIG. 12 is a top view of a hybrid flex according to an embodiment of the present invention;

FIG. 13 is a side view of the hybrid flex of FIG. 12;

FIG. 14 is a top view of a hybrid flex that includes a thin-film multi-ferroic structure according to an embodiment of the present invention;

FIG. 15 is a side view of the hybrid flex of FIG. 14;

FIG. 16A and FIG. 16B illustrate a thin-film multi-ferroic structure according to an embodiment of the present invention;

FIG. 17A and FIG. 17B illustrate a thin-film multi-ferroic structure according to an embodiment of the present invention; and

FIG. 18 illustrates a low-profile hybrid flex connector according to an embodiment of the present invention.

### DESCRIPTION OF ILLUSTRATIVE EMBODIMENTS

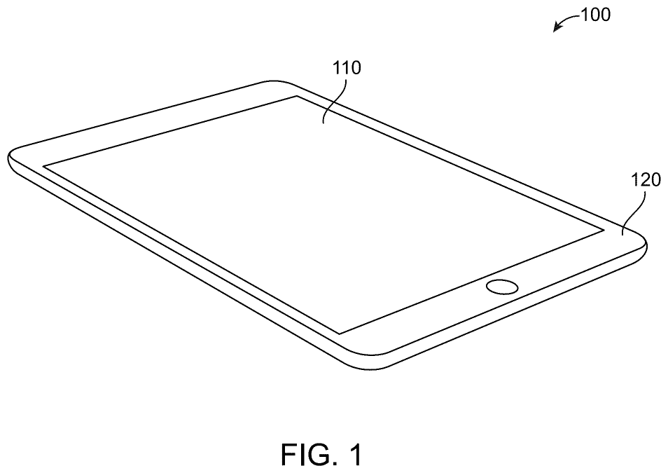

FIG. 1 illustrates an electronic device that can be improved by the incorporation of an embodiment of the present invention. Electronic device 100 can include enclosure 120 supporting screen 110. Electronic device 100 can include connectors, processors, sensors, wireless communication circuits, cameras, memories, and other electronic circuits and components (not shown.) These circuits can share vast amounts of data at very high speeds. These circuits can also be placed a distance away from each other inside electronic device 100. There can also be other circuits and components that be placed between these communicating circuits. Accordingly, embodiments of the present invention can provide communication paths that can convey high-seed signals a distance in electronic device and are highly flexible such that they can be routed around intervening structures.

While electronic device 100 is shown as a tablet computer, electronic device 100 can be another type of an electronic device, such as a laptop computer, desktop computer, all-in-one computer, cell phone, storage device, wearable-computing device, portable computing device, portable media player, navigation system, monitor, audio device, remote, adapter, and other device.

While embodiments of the present invention are well-suited to use for communication between two circuits in an electronic device, they can also be used in transferring data and power between two electronic devices. For example, embodiments of the present invention can be used in cables and other structures.

An illustrate embodiments of the present invention can provide a highly flexible, high-speed interconnect structure. The interconnect structure, which can be referred to as a hybrid flexible circuit board, or simply hybrid flex, can include one, two, three, four, or more than four first microcoaxial cables, referred to here as microcoax cables. The interconnect structure can further include one, two, three, four, or more than four power and ground conductors for power supplies, grounds, and other high-current paths. The interconnect structure can include one, two, three, four, or more than four second microcoax cables.

The conductors for this hybrid flex can be arranged in various ways. For example, four first microcoax cables can be positioned on a first side and two second microcoax cables can be placed on a second side. Three power and ground conductors can be placed between the first microcoax cables and the second microcoax cables. The three power and ground conductors can be allocated as one power conductor and two ground conductors.

The first microcoax cables and the second microcoax cables can be similar or the same, or they can be different. The first microcoax cables and second microcoax cables can each include a center conductor for conveying a signal, and insulating layer, and an outside ground shield. The ground shields for each microcoax cable can attach to a layer of copper, copper alloy, or other conductive material on a bottom side. They can further attach to a layer of copper, copper alloy, or other conductive material on a top side.

The power and ground conductors can be solid wires, they can be stranded wires, they can be magnet, enameled wire, or they can be other types of wire.

The first microcoax cables, the power and ground conductors, and the second microcoax cables can be secured to each other in an insulating layer. The insulation layer can be formed of polyimide or other insulating material that is flexible. The copper, copper alloy, or other conductive layers can be attached to either or both a top side and a bottom side of the insulating material. The copper, copper alloy, or other conductive layers can contact or connect to the ground shields for the first microcoax cables and the second microcoax cables. The copper, copper alloy, or other conductive layers can contact or connect to the ground conductors. The power conductors can be isolated from the copper, copper alloy, or other conductive layers using pieces or layers of insulation. An example is shown in the following figures.

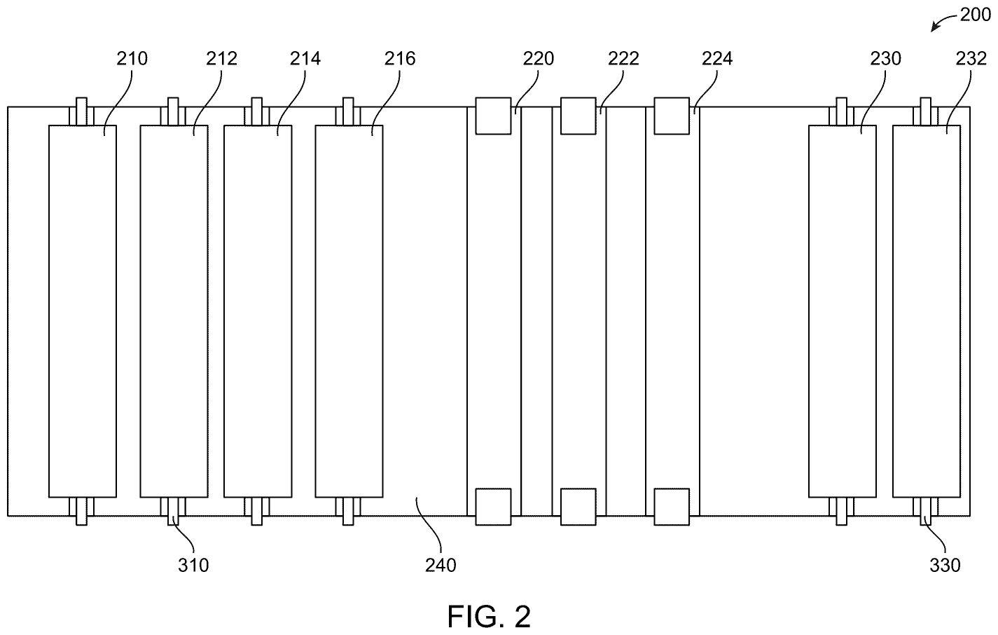

FIG. 2 is a top view of a hybrid flex according to an embodiment of the present invention. Hybrid flex 200 can include one, two, three, four, or more than four first microcoax cables, shown here as microcoax cable 210, microcoax cable 212, microcoax cable 214, and microcoax cable 216 (collectively referred to as first microcoax cables 210.) Hybrid flex 200 can further include one, two, three, four, or more than four power and ground conductors for power supplies, grounds, and other high-current paths, shown here as conductor 220, conductor 222, and conductor 224 (collectively referred to power and ground conductors 220 or conductors 220.) Hybrid flex 200 can further include one, two, three, four, or more than second first microcoax cables, shown here as microcoax cable 230 and microcoax cable 232 (collectively referred to as second microcoax cables 230.) Power and ground conductors 220 can be positioned between first microcoax cables 210 and second microcoax cables 230. Power and ground conductors 220 can be solid wires, they can be stranded wires, they can be magnet wires (mag wires), enameled wire, or they can be other types of wire.

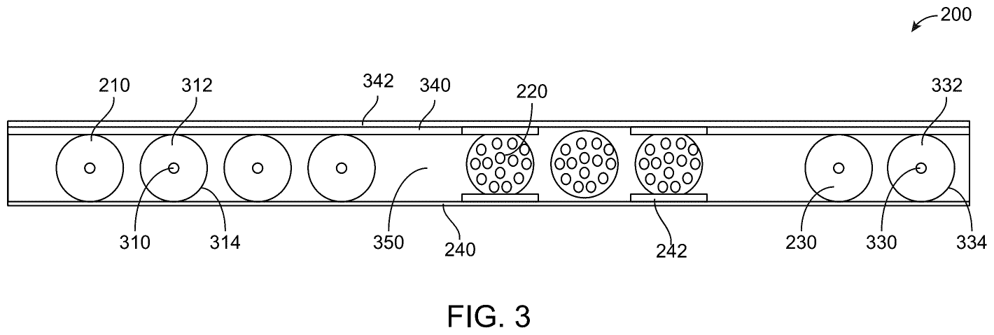

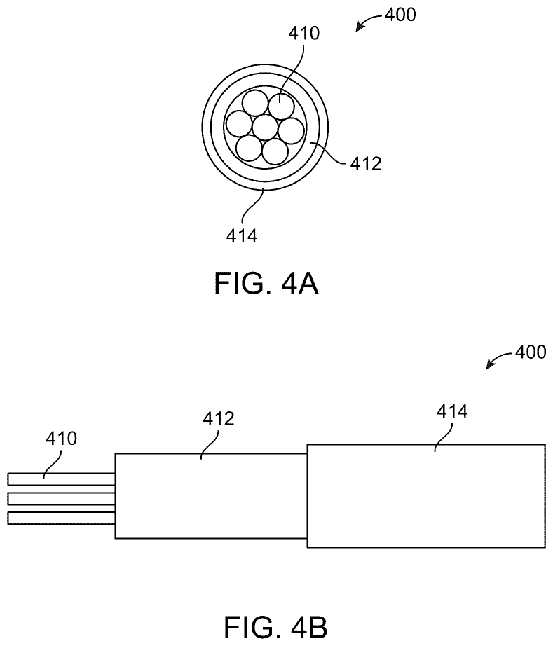

First microcoax cables 210, power and ground conductors 220, and second microcoax cables 230 can be placed on bottom conductive layer 240. Center conductors 310 and center conductors 330 can be available beyond edges of bottom conductive layer 240 for soldering to a board or other structure. Bottom conductive layer 240 can electrically connect with a ground shield or an outer shield 414 (shown in FIG. 4A and FIG. 4B) of each of the first microcoax cables 210 and second microcoax cables 230. Bottom conductive layer 240 can be insulated from power conductors 220 by insulating pieces 242 (shown in FIG. 3.) Insulating pieces 242 can be formed of polyethylene or other flexible insulator. Bottom conductive layer 240 can be formed of copper, copper alloy, or other conductive material. An insulating layer 350 (shown in FIG. 3) can be formed on bottom conductive layer 240. Insulating layer 350 can be formed of polyimide or other material. Insulating layer 350 can secure first microcoax cables 210, power and ground conductors 220, and second microcoax cables 230 in position on bottom conductive layer 240. Top conductive layer 340 (shown in FIG. 3) can be placed over first microcoax cables 210, power and ground conductors 220, and second microcoax cables 230. Top conductive layer 340 can electrically connect with an outer shield 414 of each of the first microcoax cables 210 and second microcoax cables 230. Top conductive layer 340 can be insulated from power conductors 220 by insulating pieces 242. Top conductive layer 340 can be formed of copper, copper alloy, or other conductive material. An optional protective coverlay layer 342 (shown in FIG. 3) can be formed over either or both bottom conductive layer 240 and top conductive layer 340.

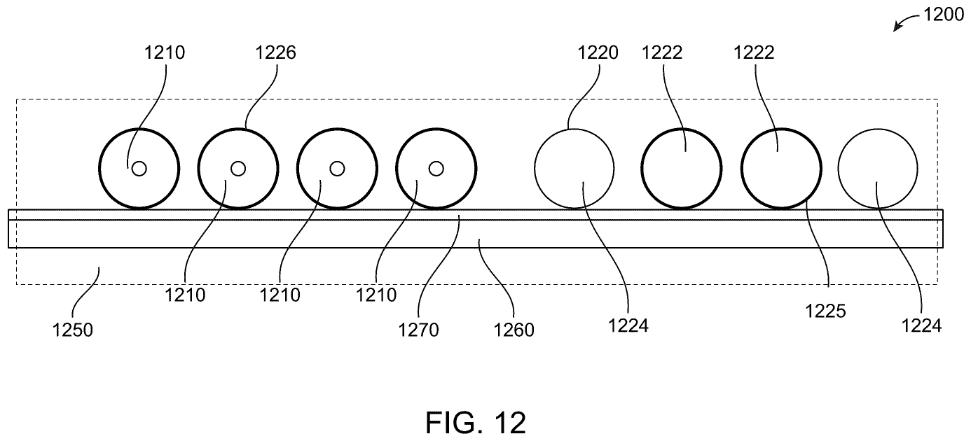

FIG. 3 is a cutaway side view of the hybrid flex of FIG. 2. Hybrid flex 200 can include first microcoax cables 210. Hybrid flex 200 can further include power and ground conductors 220. Hybrid flex 200 can further include second microcoax cables 230. Power and ground conductors 220 can be positioned between first microcoax cables 210 and second microcoax cables 230. First microcoax cables 210, power and ground conductors 220, and second microcoax cables 230 can be placed on bottom conductive layer 240. Bottom conductive layer 240 can electrically connect with an outer shield 314 of each of the first microcoax cables 210 and outer shield 334 of each of the second microcoax cables 230. Outer shield 314 and outer shield 334 can be the same as or similar to outer shield 414 (shown in FIG. 4A and FIG. 4B.) Bottom conductive layer 240 can contact ground conductor 222 and can be insulated from power conductors 220 and 224 (all shown in FIG. 2) by insulating pieces 242. Bottom conductive layer 240 can be formed of copper, copper alloy, or other conductive material. Insulating layer 350 can be formed on bottom conductive layer 240. Insulating layer 350 can secure first microcoax cables 210, power and ground conductors 220, and second microcoax cables 230 in position on bottom conductive layer 240. Top conductive layer 340 can be placed over first microcoax cables 210, power and ground conductors 220, and second microcoax cables 230. Top conductive layer 340 can electrically connect with outer shield 314 of each of the first microcoax cables 210 and outer shield 334 of each of the second microcoax cables 230. Top conductive layer 340 can contact ground conductor 222 and can be insulated from power conductors 220 and 224 by insulating pieces 242. Top conductive layer 340 can be formed of copper, copper alloy, or other conductive material. An optional protective coverlay layer 342 can be formed over either or both bottom conductive layer 240 and top conductive layer 340. Conductive adhesive, such as conductive adhesive 1270 (shown in FIG. 12) can be used to adhere first microcoax cables 210, power and ground conductors 220, and second microcoax cables 230 to either or both bottom conductive layer 240 and top conductive layer 340.

First microcoax cables 210 can include center conductor 310, insulating layer 312, and outer shield 314. Second microcoax cables 230 can include center conductor 330, insulating layer 332, and outer shield 334. First microcoax cables 210 and second microcoax cables 230 can be similar or the same, or they can be different. Center conductor 310 and center conductor 330 can be similar or the same, or they can be different. First microcoax cables 210 and second microcoax cables 230 can be the same as or similar to microcoax cable 400 shown in FIG. 4A and FIG. 4B.

First microcoax cables 210, power and ground conductors 220, and second microcoax cables 230 can have various gauges. Using a higher gauge, narrower wire can result in a more flexible hybrid flex. For example, a gauge of less than 38, 38, 43, 46, or more than 46 can be used. The term gauge used here refers to the American Wire Gauge (AWG) or Brown & Sharpe wire gauge. These gauges can be used for conductors in each of these and other embodiments of the present invention.

These and other embodiments of the present invention can utilize various microcoax cables. These microcoax cables can have a center conductor. The center conductor can be a solid wire or a stranded wire, such as a Litz wire. The center conductor can be insulated with an insulating layer. The outer side of the insulating layer can be covered with a metalized shield. For example, the insulating layer can be covered in a shield formed of a conductive braiding, foil, or other type of layer. This shielding can be formed of copper, copper alloy, aluminum, or other material. An example is shown in the following figures.

FIG. 4A and FIG. 4B illustrate a microcoax cable used in embodiments of the present invention. In FIG. 4A, microcoax cable 400 can have a stranded core or center conductor 410, a jacket or insulating layer 412, and outer shield 414. Insulating layer 412 can be formed of polyethylene or other flexible insulating material. Outer shield 414 can be formed of copper, copper alloy, aluminum, or other conducive material. Outer shield 414 can be a braided, a foil, or other type of layer. In FIG. 4B, in preparation for soldering to a board or other substrate, outer shield 414 can be stripped or removed to expose insulating layer 412 and center conductor 410. Insulating layer 412 can be stripped or removed to expose center conductor 410.

Microcoax cable 400 can be used as first microcoax cables 210, second microcoax cables 230, and the other microcoax cables shown herein. For example, center conductor 410 can be the same as or similar to center conductor 310 and 330 (shown in FIG. 2.)

These microcoax cables can be soldered to a circuit board or other substrate using jet soldering. For example, the center conductor can be soldered to a trace of a board using jet soldering. One or both sides of a shield can be soldered to one or more ground pads of a circuit board or other substrate using jet soldering. An example is shown in the following figure.

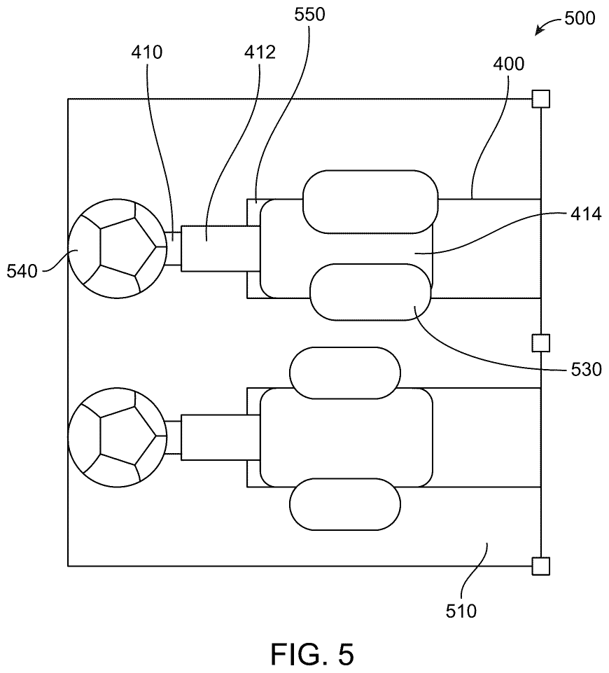

FIG. 5 illustrates soldered structures formed using jet-soldering according to an embodiment of the present invention. In system 500, outer shield 414 of microcoax cable 400 can be soldered to ground pad 550 on board 510 by solder beads 530. Center conductor 410 can be soldered to a signal pad (not shown) on board 510 by solder bead 540. Solder beads 530 and solder bead 540 (collectively referred to as solder beads 530) can be formed by jet soldering or other technique. Insulating layer 412 can help to isolate solder bead 540 from solder beads 530.

This jet soldering can include feeding a solder ball to a nozzle. The solder balls can be stored in a hopper awaiting their turn. The solder ball can be heated with a laser or by other method. The solder ball can be heated with a laser and then expelled by pressurized nitrogen towards a target. An example is shown in the following figure.

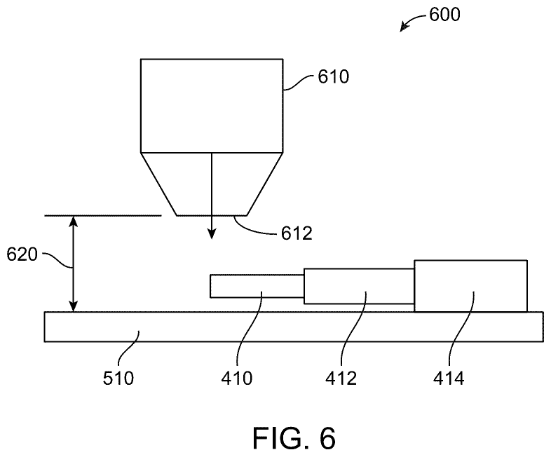

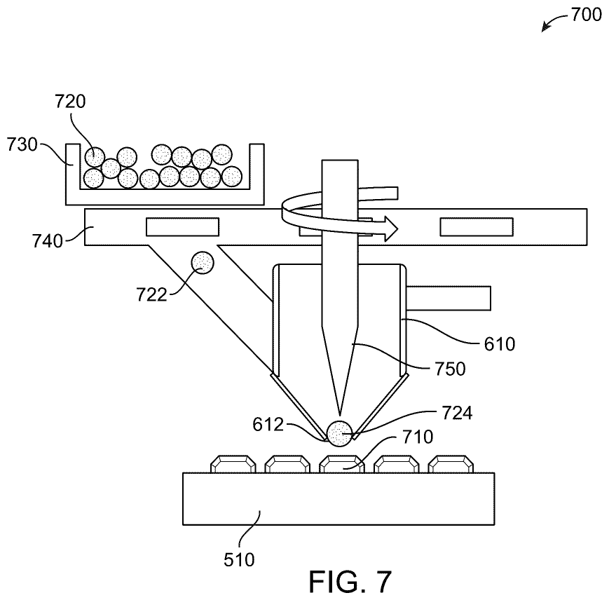

FIG. 6 illustrates an apparatus and method of forming solder-jet connections according to an embodiment of the present invention. In system 600, solder balls 720 (shown in FIG. 7) can be fed into nozzle 610, heated, and ejected from opening 612 at a height 620. The solder ball can then form a solder bead 530 (shown in FIG. 5) that can solder center conductor 410 to a pad (not shown) on board 510. Outer shield 414 can be soldered to a ground pad in the same or similar manner. Insulating layer 412 can predominantly set a height of center conductor 410 relative to the top surface of board 510.

FIG. 7 illustrates an apparatus and method of forming solder-jet connections according to an embodiment of the present invention. Solder balls 720 can be stored in hopper 730 in system 700. Solder balls 720 be fed through mechanism 740 as solder ball 722 and into nozzle 610 as solder ball 724. Solder ball 724 can be heated, for example by laser 750. Solder ball 724 can then be expelled from opening 612 by pressurized nitrogen towards target 710 on board 510.

Measured performance of the hybrid flex cable shows a greatly improved structure for transmitting high-speed signals over a distance. Examples are shown in the following figures.

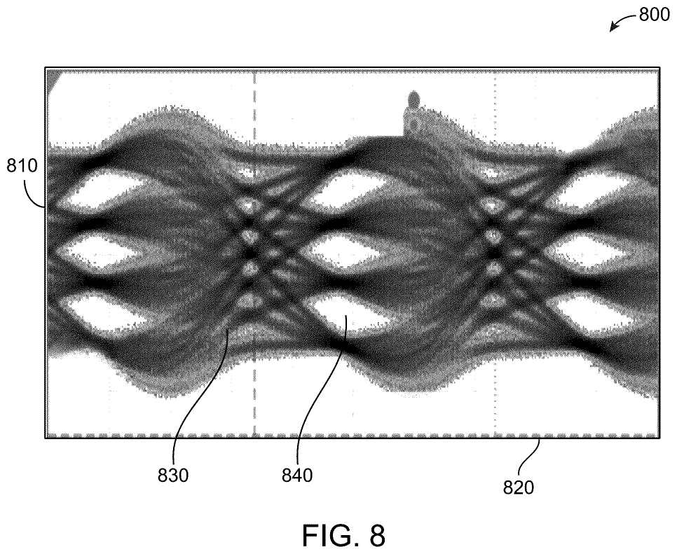

FIG. 8 illustrates an eye diagram for a PAM4 signal being conveyed by a hybrid flex according to an embodiment of the present invention. Graph 800 shows PAM4 output signal 830 as a function of amplitude 810 and time 820. PAM4 output signal 830 has eyes 840 that are wide and can provide accurate data recovery. PAM4 output signal 830 can be data received through a 30 centimeter hybrid flex provided by an embodiment of the present invention. In one example, data rates greater than 400 Gbit/sec over 30 cm distances with 4 channels can be achieved. This example can achieve these data rates using a fraction of the power consumption required by conventional techniques with massive equalization.

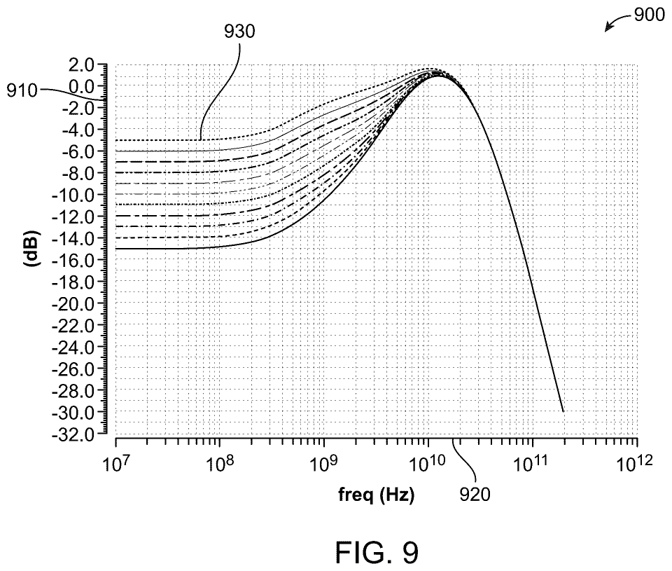

FIG. 9 illustrates the pre-emphasis that can be used in transmitting the PAM4 of FIG. 8. Preemphasis 930 is shown in graph 900 as a function of attenuation 910 and frequency 920. In one example, a low-frequency equalization of −14 dB can be used.

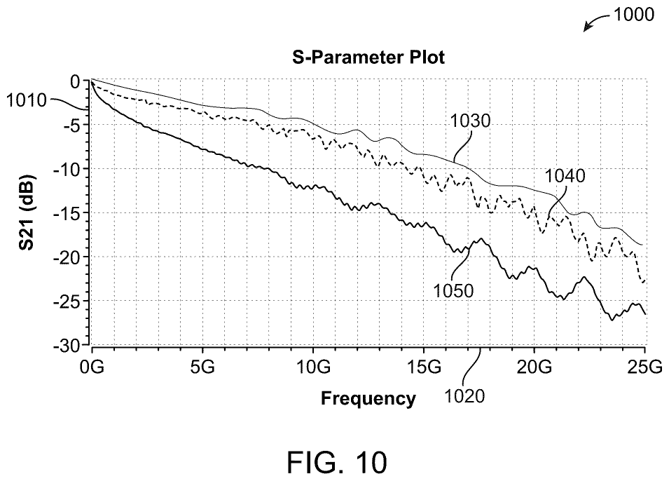

FIG. 10 illustrates the insertion loss for a hybrid flex according to an embodiment of the present invention. Graph 1000 can show insertion loss as a function of attenuation 1010 at frequency 1020. Insertion loss 1030 can be the insertion loss for a 30 centimeter hybrid flex provided by an embodiment of the present invention that uses 43 AWG (gauge) microcoax cables. Insertion loss 1040 can be the insertion loss for a 30 centimeter hybrid flex provided by an embodiment of the present invention that uses narrower 46 gauge microcoax cables. Insertion loss 1050 is shown for comparison and can be the insertion loss for a much shorter 11.4 centimeter conventional flexible circuit board.

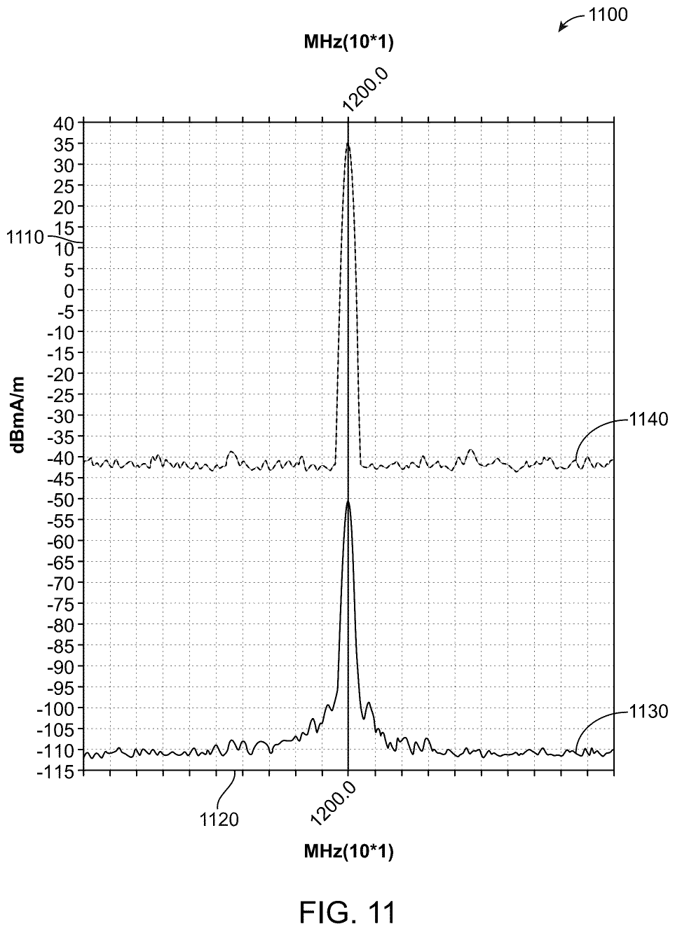

FIG. 11 illustrates the electromagnetic interference generated by a hybrid flex according to an embodiment of the present invention. Graph 1100 shows interference as a function of amplitude 1110 and frequency 1120. Interference 1130 can be the interference from a 30 centimeter hybrid flex provided by an embodiment of the present invention. A much higher amount of interference 1140 is shown for comparison and can be the interference for a much shorter 11.4 centimeter conventional flexible circuit board.

These hybrid flexes can be arranged in various ways. An example is shown in the following figures.

FIG. 12 is a side view of another hybrid flex according to an embodiment of the present invention. Hybrid flex 1200 can include first microcoax cables 1210. In this example, four first microcoax cables 1210 can be included, though one, two, three, or more than four first microcoax cables 1210 can be included in these and other embodiments of the present invention. Four power and ground conductors 1220 can be included in hybrid flex 1200, though one, two, three, or more than four power and ground conductors 1220 can be included in hybrid flex 1200. Power and ground conductors 1220 can include two power supply conductors 1222, though other numbers of power supply conductors 1222, such as one or more than two power supply conductors 1222 can be included. Power and ground conductors 1220 can include two ground conductors 1224, though other numbers of ground conductors 1224, such as one or more than two ground conductors 1224 can be included.

First microcoax cables 1210 and power and ground conductors 1220 can be attached to bottom conductive layer 1260 using conductive adhesive 1270. Bottom conductive layer 1260 can connect to outer shields 1226 of first microcoax cables 1210 and ground conductors 1224. Power supply conductors 1222 can be insulated by coating 1225. Power supply conductors 1222 and coating 1225 can be mag wires, magnet wire, enameled wire, or other type of protected wire. First microcoax cables 1210 and power and ground conductors 1220 can be covered with insulating layer 1250. Insulating layer 1250 can be formed of polyimide or other material.

First microcoax cables 1210 can be the same as or similar to microcoax cables 400 (shown in FIG. 4A and FIG. 4B.) For example, outer shield 1226 can be the same as or similar to outer shield 414 (shown in FIG. 4A and FIG. 4B.) Bottom conductive layer 1260 can be formed of copper, copper alloy, or other flexible conductive material and can be the same as or similar to top conductive layer 340 and bottom conductive layer 240 in FIG. 2. Insulating layer 1250 can be formed of polyimide or other material and can be the same as or similar to insulating layer 350 in FIG. 3.

First microcoax cables 1210 and power and ground conductors 1220 can have various gauges. Using a higher gauge, narrower wire can result in a more flexible hybrid flex. For example, a gauge of less than 38, 38, 43, 46, or more than 46 can be used. The term gauge used here refers to the American Wire Gauge (AWG) or Brown & Sharpe wire gauge. These gauges can be used for conductors in each of these and other embodiments of the present invention.

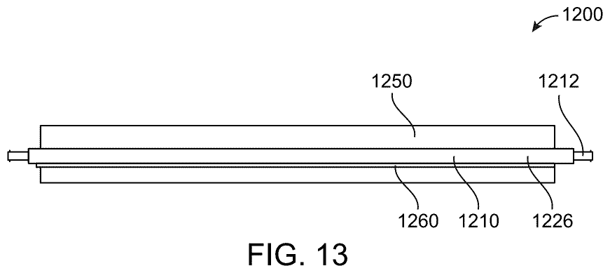

FIG. 13 is a side view of the hybrid flex of FIG. 12. Hybrid flex 1200 can include first microcoax cable 1210 and bottom conductive layer 1260. First microcoax cable 1210 can be attached to bottom conductive layer 1260 using conductive adhesive 1270 (shown in FIG. 12.) First microcoax cable 1210 can include center conductor 1212, which can be the same as or similar to center conductor 410 (shown in FIG. 4A and FIG. 4B.) First microcoax cable 1210 can be covered with insulating layer 1250. Outer shield 1226 can be electrically connected to bottom conductive layer 1260.

These and other embodiments of the present invention can include various passive and active components in a hybrid flex. For example, components for filter power supply voltages, terminating cables, and other components can be included. These components can be surface mount contacting capacitors, resistors, or other types of passive or active device. These components can be formed of thin film multi-ferroics. For example, ferroelectric tunable thin-film capacitors can be included. These thin-film capacitors can decouple power supply voltages conveyed on one of the power and ground conductors. Such a capacitor can be connected between a power supply conductor and a ground conductor. Control voltages can be conveyed to the thin-film capacitors via wires in the hybrid flex. Other components, such as a choke, can be included. Filter circuits such as Pi filters, voltage tunable pi filters, and other power line noise filters can be implemented. The choke can be implemented using a ferromagnetic thin-film ferrite. These structures can be fabricated in the hybrid flex using planar fabrication techniques.

For example, a number of microcoax cables and other conductors can be partially molded in an insulator such that a bottom portion of the microcoax cables are molded a top portion are not molded. Conductive traces or other conduits for power and ground can be placed on this middle level of insulator. Thin-film multi-ferroic structures such as capacitors and chokes can be formed in contact with these conductive traces or other conduits. The remaining exposed portions of the microcoax cables can be molded. An example is shown in the following figures.

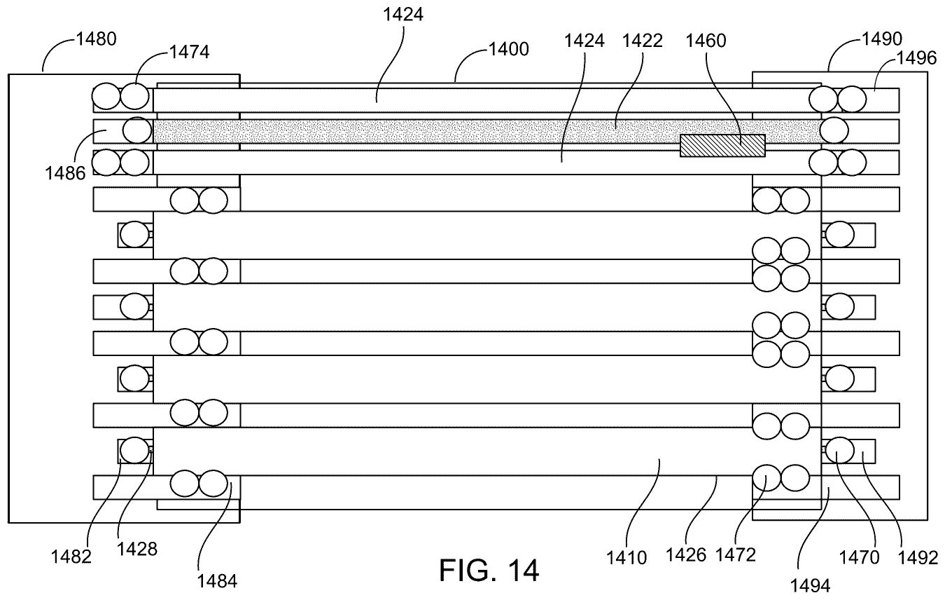

FIG. 14 is a top view of a hybrid flex that includes a thin-film multi-ferroic structure according to an embodiment of the present invention. Hybrid flex 1400 can convey signals from first board 1480 to second board 1490. Hybrid flex 1400 can include a number of first microcoax cables 1410. In this example, four first microcoax cables 1410 are shown, though other numbers of first microcoax cables 1410 can be included, such as one, two, three, or more than four first microcoax cables 1410. Hybrid flex 1400 can include one power supply conductor 1422, though other numbers of power supply conductors 1422 can be included. For example, more than one power supply conductor 1422 can be included. Two ground conductors 1424 can be included, though other numbers of ground conductors, such as one, three, or more than three ground conductors can be included. Variable capacitor 1460 can also be included. Variable capacitor 1460 can be connected to power supply conductor 1422 and ground conductor 1424. Variable capacitor 1460 can help to filter and remove power supply noise from power supply conductor 1422 by coupling the voltage on power supply conductor 1422 to ground.

First microcoax cables 1410 can include center conductors 1428 that can be soldered to pads 1482 on first board 1480 and pads 1492 on board for 1490 using solder beads 1470. Outer shields 1426 can be soldered using solder beads 1472 to pads 1484 on first board 1480 and pads 1494 on second board 1490. Power supply conductor 1422 and ground conductors 1424 can be soldered using solder beads 1474 to pads 1486 on first board 1480 and pads 1496 on second board 1490. Solder beads 1470, solder beads 1472, and solder beads 1474 can be formed using the techniques described in FIG. 6 and FIG. 7 and elsewhere herein.

First microcoax cables 1410 can have various gauges. Using a higher gauge, narrower wire can result in a more flexible hybrid flex. For example, a gauge of less than 38, 38, 43, 46, or more than 46 can be used. The term gauge used here refers to the American Wire Gauge (AWG) or Brown & Sharpe wire gauge. These gauges can be used for conductors in each of these and other embodiments of the present invention.

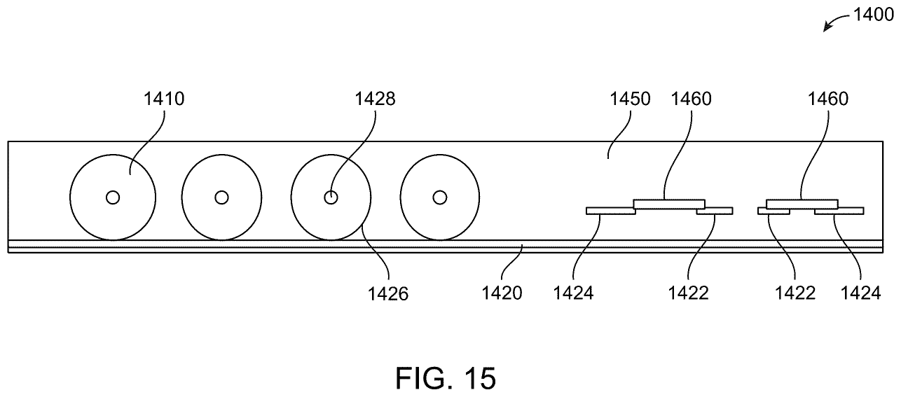

FIG. 15 is a side view of the hybrid flex of FIG. 14. Hybrid flex 1400 can include a number of first microcoax cables 1410. First microcoax cables 1410 can include center conductor 1428 and outer shield 1426. Outer shields 1426 can be electrically connected to bottom conductive layer 1420. Center conductor 1428 can be the same as or similar to center conductor 410, while outer shield 1426 can be the same or similar to outer shield 414 (both shown in FIG. 4A and FIG. 4B. Outer shields 1426 of first microcoax cables 1410 can be attached to, and electrically connected to, bottom conductive layer 1420. Hybrid flex 1400 can be encased in insulating layer 1450. Insulating layer 1450 can be formed of polyimide or other insulating material.

Hybrid flex 1400 can further include variable capacitors 1460. Variable capacitors 1460 can be connected between power supply conductor 1422 and ground conductor 1424. During manufacturing, insulating layer 1450 can be applied until a mid-level of hybrid flex 1400 is reached. Power supply conductors 1422 and ground conductors 1424 can be placed on insulating layer 1450 at that time. Variable capacitor 1460 can be formed on the mid-level of insulating layer 1450 using planar fabrication techniques. After formation of variable capacitor 1460, the remaining portion of insulating layer 1450 can be applied. Optional conductive layers and coverlay layers can be added as well.

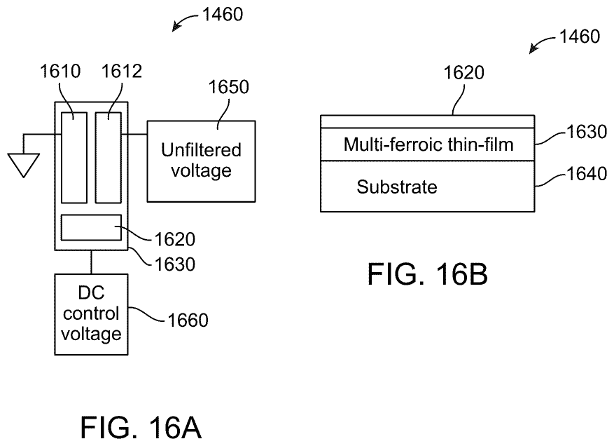

FIG. 16A and FIG. 16B illustrate a thin-film multi-ferroic structure according to an embodiment of the present invention. Variable capacitor 1460 can include contact 1610 and contact 1612. Contact 1610 can connect to ground conductor 1424 (shown in FIG. 14) while contact 1612 can connect to filter voltage 1650 on power supply conductor 1422 (shown in FIG. 14.) A DC control voltage 1660 can be applied at contact 1620 to thin film 1630, which can reside on substrate 1640. The DC voltage can be varied to adjust the value of variable capacitor 1460. Thin film 1630 can be formed of Bismuth Ferrous Oxide, or multiferroic GaₓFe₂₋ₓ O₃. Thin film 1630 can be formed of CoFe₂O₄ (CFO) or LSMO/0.68Pb(Mg_{1/3}Nb_{2/3})O₃-0.32PbTiO₃ (PMN-PT). Thin film 1630 can exhibit ferroelectricity and also ferromagnetic behavior and can help filter mid-high frequency noise. Thin film 1630, substrate 1640, and contacts 1610, 1612, and 1620 can be formed using planar fabrication techniques. Variable capacitor 1460 and other thin film structures can be used in forming filter circuits such as Pi filters, voltage tunable pi filters, and other power line noise and other filters.

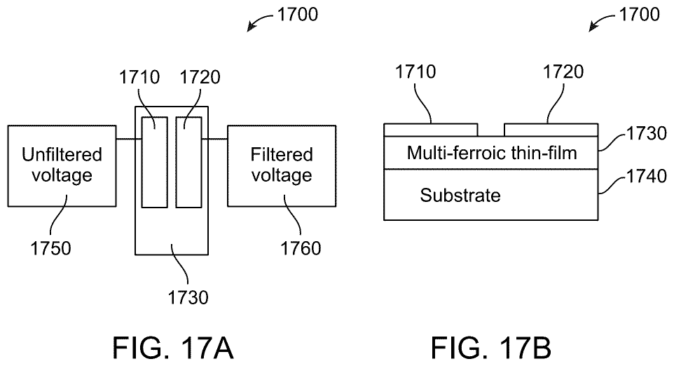

FIG. 17A and FIG. 17B illustrate a thin-film multi-ferroic structure according to an embodiment of the present invention. Ferrite 1700 can include contact 1710 and contact 1720. Contact 1710 can connect to a voltage 1750 to be filtered while contact 1720 can provide a filtered voltage 1760. Contact 1710 and contact 1720 can reside on thin film 1730, which can reside on substrate 1740. Thin film 1730 can be formed of Bismuth Ferrous Oxide, or multiferroic GaₓFe₂₋ₓ O₃. Thin film 1730 can be formed of CoFe₂O₄ (CFO) or LSMO/0.68Pb(Mg_{1/3}Nb_{2/3})O₃-0.32PbTiO₃ (PMN-PT). Thin film 1730 can exhibit ferroelectricity and also ferromagnetic behavior and can help filter mid-high frequency noise. Thin film 1730, substrate 1740, and contacts 1710 and 1720 can be formed using planar fabrication techniques. Ferrite 1700 can be used as a choke. Ferrite 1700 and other thin film structures can be used in forming filter circuits such as Pi filters, voltage tunable pi filters, and other power line noise and other filters.

These and other embodiments of the present invention can provide a low-profile hybrid flex connector. This connector can include a hybrid flex having conductors terminating in solder connections to pads on top of a first board. A polyimide mold (or ferrite loaded mold/EMI absorber) can be placed over the solder terminations and pads on the first board. That is, the solder terminations (or the solder-microcoax-board interface) can be coated with polyimide or nano-powder spinel ferrite loaded acrylic or other suitable molding absorber films as an EMI absorber. The first board can have through connections to pads on the bottom of the first board. The pads on the bottom of the board can connect to pads on a second board. The second board can be a main-logic board or other board. The pads on the bottom of the first board can be connected to pads on the second board using an anisotropic conductive film. The first board and the second board can be connected to each other using interlocking screws or other fasteners. An example is shown in the following figure.

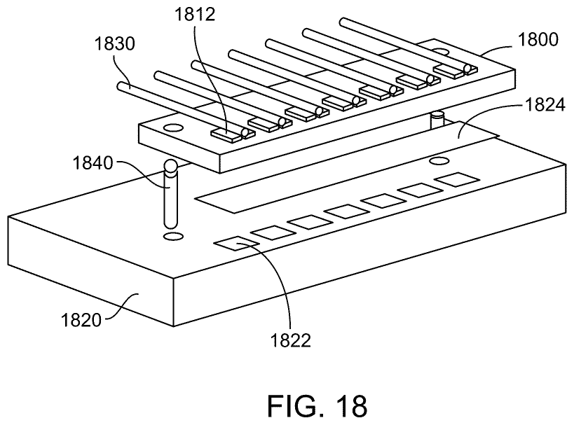

FIG. 18 illustrates a low-profile hybrid flex connector according to an embodiment of the present invention. Hybrid flex connector 1800 can include a number of microcoax cables, power and ground conductors, and other conductors, shown here generically as conductors 1830. Conductors 1830 can be soldered to pads 1812. Hybrid flex connector 1800 can include pads (not shown) on a bottom side. These bottom side pads can be attached to pads 1822 on a surface of board 1820 using anisotropic conductive film 1824. Hybrid flex connector 1800 can be attached to board 1820 using fasteners 1840. Fasteners 1840 can be interlocking screws or other fasteners.

Embodiments of the present invention can provide hybrid flexes that can be located in various types of devices, such as tablet computers, laptop computers, desktop computers, all-in-one computers, cell phones, storage devices, wearable-computing devices, portable computing devices, portable media players, navigation systems, monitors, audio devices, remotes, adapters, and other devices.

While embodiments of the present invention are well-suited to use in connector receptacles, these and other embodiments of the present invention can be utilized in connector inserts and other types of connectors as well.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A hybrid flex cable comprising:
a first layer of conductive material;
a first plurality of microcoax cables;
a first plurality of power and ground conductors;
a second plurality of microcoax cables, wherein the first plurality of microcoax cables, the first plurality of power and ground conductors, and the second plurality of microcoax cables are arranged in a plane on or near the first layer of conductive material; and
an insulating layer formed on the first layer of conductive material and around the first plurality of microcoax cables, the first plurality of power and ground conductors, and the second plurality of microcoax cables.

2. The hybrid flex cable of claim 1 wherein the first layer of conductive material comprises copper.

3. The hybrid flex cable of claim 1 wherein the first layer of conductive material comprises copper alloy.

4. The hybrid flex cable of claim 2 wherein the insulating layer comprises polyimide.

5. The hybrid flex cable of claim 2 wherein first plurality of power and ground conductors comprises two conductors for ground and one conductor for a power supply, wherein the one conductor for a power supply is insulated from the first layer of conductive material.

6. The hybrid flex cable of claim 5 wherein the first plurality of power and ground conductors are formed of stranded wire.

7. The hybrid flex cable of claim 6 wherein the hybrid flex cable comprises four first plurality of microcoax cables and two second microcoax cables.

8. The hybrid flex cable of claim 2 wherein the first plurality of power and ground conductors are positioned in a plane with and between the first plurality of microcoax cables and the second plurality of microcoax cables.

9. The hybrid flex cable of claim 2 wherein the first plurality of microcoax cables comprises a first microcoax cable, the first microcoax cable comprising a center conductor, an insulating layer, and an outer shield.

10. The hybrid flex cable of claim 9 wherein the first microcoax cable is attached to a board by soldering a first side of the outer shield to a ground pad on the board and soldering a second side of the outer shield to the ground pad using jet soldering.

11. The hybrid flex cable of claim 9 wherein the first microcoax cable is attached to a board by soldering the center conductor to a signal pad on the board using jet soldering.

12. The hybrid flex cable of claim 2 further comprising a second layer of conductive material over the insulating layer.

13. The hybrid flex cable of claim 12 wherein the first layer of conductive material electrically and physically contacts an outer shield on each of the first plurality of microcoax cables and each of the second plurality of microcoax cables.

14. The hybrid flex cable of claim 13 wherein the second layer of conductive material electrically and physically contacts an outer shield on each of the first plurality of microcoax cables and each of the second plurality of microcoax cables.

15. A hybrid flex cable comprising:
a first layer of conductive material;
a first plurality of microcoax cables, wherein the first plurality of microcoax cables are arranged in a plane on or near the first layer of conductive material;
a first power conductor;
a first ground conductor;
a first multi-ferroic thin film structure connected to the first power conductor and the first ground conductor; and
an insulating layer formed on the first layer of conductive material and around the first plurality of microcoax cables, the first power conductor, the first ground conductor, and the first multi-ferroic thin film structure.

16. The hybrid flex cable of claim 15 wherein the first multi-ferroic thin film structure is a tunable capacitor.

17. The hybrid flex cable of claim 15 wherein the first multi-ferroic thin film structure is a ferrite.

18. The hybrid flex cable of claim 15 further comprising:
a second power conductor;
a second ground conductor; and
a second multi-ferroic thin film structure connected to the second power conductor and the second ground conductor.

19. The hybrid flex cable of claim 18 wherein the second multi-ferroic thin film structure is a tunable capacitor.

20. The hybrid flex cable of claim 18 wherein the first multi-ferroic thin film structure is a ferrite.
